(19) United States
(12) Patent Application Publication
(10) Pub. No.: US 2013/0048115 A1
(43) Pub. Date: Feb. 28, 2013

(54) LUBRICANT DRAIN PLUG SYSTEM

(71) Applicant: Richard J. Wise, Kelowna (CA)

(72) Inventor: Richard J. Wise, Kelowna (CA)

(73) Assignee: R-WISE TECHNOLOGY INC., Kelowna (CA)

(21) Appl. No.: 13/558,490

(22) Filed: Jul. 26, 2012

Related U.S. Application Data
(60) Provisional application No. 61/512,072, filed on Jul. 27, 2011.

(51) Int. Cl. F03B 11/02

(52) U.S. Cl. 137/561 R

(57) ABSTRACT

Disclosed is a lubricant drain plug system for a casing of moving mechanical parts in lubricant. The system comprises an adapter plug body, an oil drainage assembly threadably mountable to the adapter plug body, the assembly having an outer plug with port holes, and a valve mechanism on the adapter plug body, the valve mechanism being positionable in either an on or off position. In use, the system is inserted into the casing so that the port holes are in the lubricant and the valve is positioned in the on position so that lubricant can flow from the casing out of the system. When the valve is off, lubricant flow is stopped.

### CROSS-REFERENCE TO RELATED APPLICATION

This application claims the benefit of U.S. provisional patent application 61/512,072 filed Jul. 27, 2011, incorporated by reference herein.

### FIELD OF THE INVENTION

The present invention relates to lubricant drainage in machines. More specifically, the present invention relates to a lubricant drain plug system.

### BACKGROUND OF THE INVENTION

Plugs are inserted in the drain/fill opening of a housing for various moving components and lubricant of a machine. Examples include, but are not limited to, crankcases, transmission housings, etc. The lubricant is usually oil.

Such plugs typically have a magnetic component to attract debris from the lubricant for removal thereof from the lubricant. The use of magnetic plugs are known in the art. Indeed, one such plug has been patented in CA 1,069,403.

A problem arises when the lubricant needs to be removed from the housing; it is important to control the recovery without spillage and/or loss of lubricant from the housing.

Current systems of lubricant drainage do not allow for controlled recovery without spillage and/or loss resulting in environmental damage and lost money. It is important to note that a drop of oil contaminates one million drops of water.

The market has changed in the last 30 years from owner operators to large corporations in trucking and transport. The industry is looking for more efficient drain systems.

### SUMMARY OF THE INVENTION

Disclosed is an oil drain plug system adapted to permit easy lubricant removal from a housing. In general, the adapter plug body as used in embodiments of this invention is useable with a magnetic component to remove debris from the lubricant. This was described in the Background section of the present application. In accordance with the teachings of this invention, the magnetic component is removed from the adapter plug body.

There are many advantages in using such a disclosed lubricant drain plug system. First, the improved magnet has high strength and high heat resistance allowing more abrasive metals to be removed from circulating oil or lubricant up to 400+ degrees F. A sumarium cobalt magnet can be used, allowing for a wider range of high heat applications without loss of magnetic strength.

Embodiments of the lubricant drain plug system are made of a non ferrous main body, such as aluminum or brass, preventing thread damage to the main adapter body. The plug can also be easily replaced if damaged.

Also, use of the drain attachment allows controlled oil or lubricant to drain without spillage.

The drain mechanism in accordance with these teachings allows for controlled recovery direct to the containment vessel with no oil or lubricant loss in the field or in the shop. Embodiments of the invention help save oil, maintenance and the environment.

Other aspects and advantages of embodiments of the invention will be readily apparent to those ordinarily skilled in the art upon a review of the following description.

### BRIEF DESCRIPTION OF THE DRAWINGS

Embodiments of the invention will now be described in conjunction with the accompanying drawings, wherein:

FIG. 1 illustrates an embodiment of lubricant drain plug system in accordance with the teachings of this invention;

FIG. 2 illustrates an exploded view of an embodiment an adapter plug body and lubricant drain assembly of the lubricant drain plug system of FIG. 1;

FIG. 3 illustrates an exploded view of another embodiment an adapter plug body and lubricant drain assembly of the lubricant drain plug system of FIG. 1;

FIG. 4 illustrates the lubricant drain plug system of FIG. 1 in an “open” position;

FIG. 5 illustrates the lubricant drain plug system of FIG. 1 in a “closed” position;

FIG. 6 illustrates an embodiment of an adapter plug body;

FIG. 7 illustrates an embodiment of an adapter plug body;

FIG. 8 illustrates an embodiment of an adapter plug body;

FIG. 9 illustrates a possible use of a lubricant drain plug system in accordance with the teachings of this invention; and

FIG. 10 illustrates an embodiment of an adapter plug body;.

This invention will now be described in detail with respect to certain specific representative embodiments thereof, the materials, apparatus and process steps being understood as examples that are intended to be illustrative only. In particular, the invention is not intended to be limited to the methods, materials, conditions, process parameters, apparatus and the like specifically recited herein.

### DETAILED DESCRIPTION OF THE DISCLOSED EMBODIMENTS

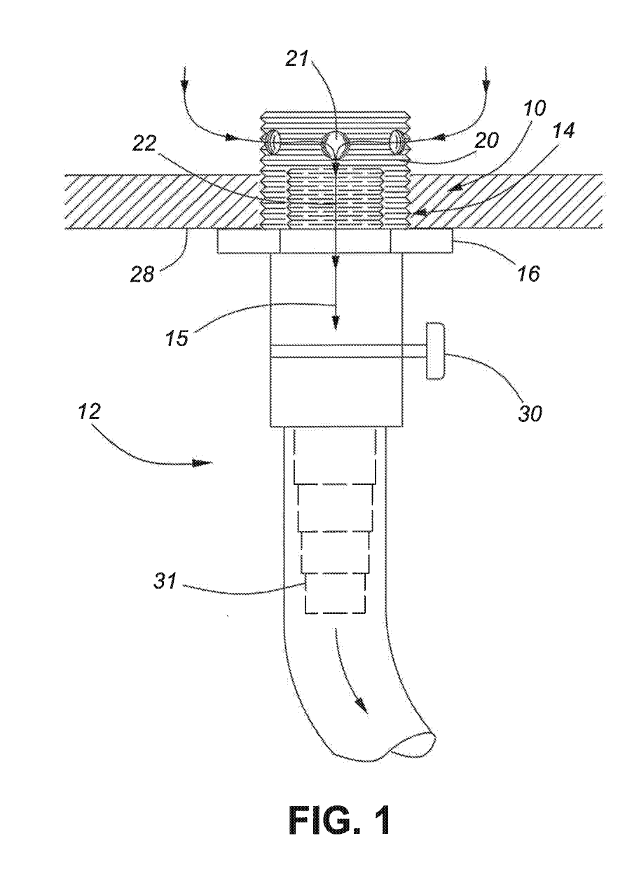

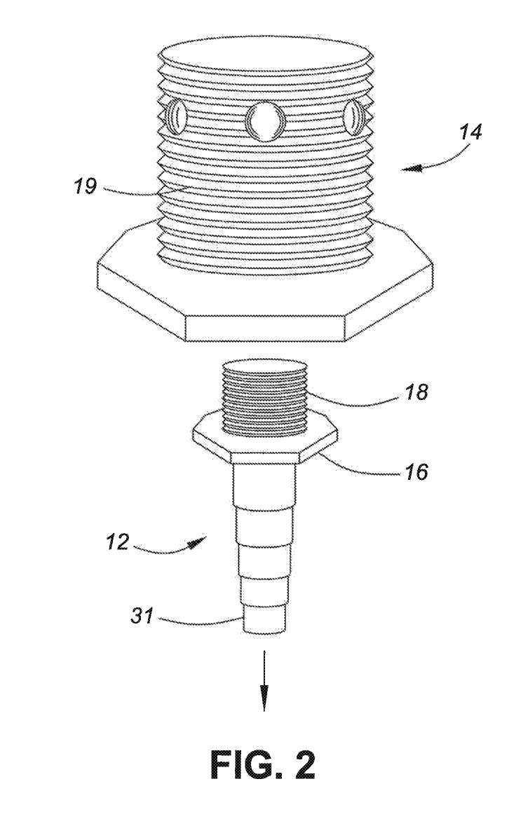

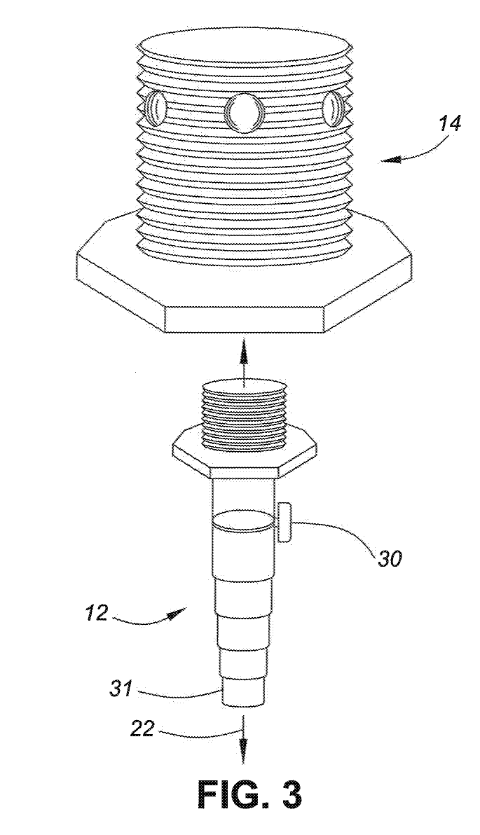

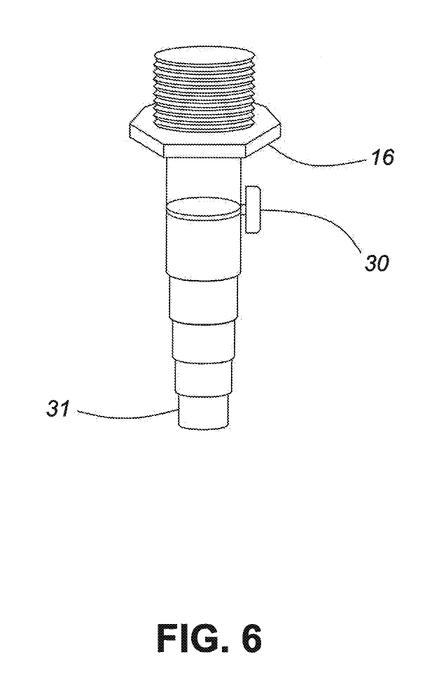

Referring to FIGS. 1 to 3, 6, a lubricant drain plug system 10 in accordance with the teachings of this invention broadly includes an adapter plug body 12 and a lubricant drain assembly 14. The lubricant drain assembly 14 is threadably mountable to the adapter plug body 12. The entire assembled system 10 defines a hollow passage therethrough 15.

The adapter plug body 12 has on one end a flanged exterior component 16, and threadable portion 18 which in use mates with a threadable portion 19 of the lubricant drain system 14. The flange allows wrench attachment for installation and removal from housings.

The lubricant drain assembly 14 has a second flanged exterior portion and an outer plug housing 20. The outer plug housing 20 has a series of port holes 21 formed therein to permit lubricant flow 22. The operation of the lubricant drain plug system 14 is described in detail below.

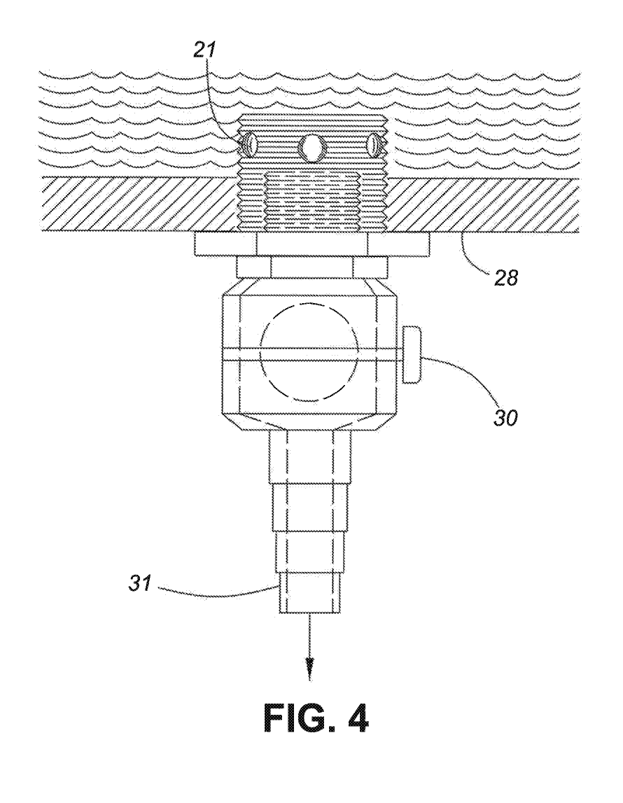

A valve mechanism 30 is incorporated within the adapter plug body 12. The valve mechanism 30 can be placed in either an ‘on’ or ‘off’ position. In the ‘on’ position, the valve mechanism 30 operates to permit lubricant flow 22 through the hollow passage 15. In the ‘off’ position, the valve mechanism 30 operates to stop lubricant flow 22 through the hollow passage 15 as seen in FIG. 4.

In use, the threaded portion 18 of the adapter plug body 12 is threaded to the threaded portion 19 of the lubricant drain assembly 14 to form a lubricant drain plug system 10. The lubricant drain plug system 10 is then mounted within an opening in the housing or casing 28. The outer plug housing 20 is placed within the lubricant itself and the valve 30 is placed in the ‘on’ position so that the lubricant can flow 22 through the port holes 21 in the outer plug housing 20 and down through the hollow passage 15 of the lubricant drain plug system 10 as seen in FIG. 4.

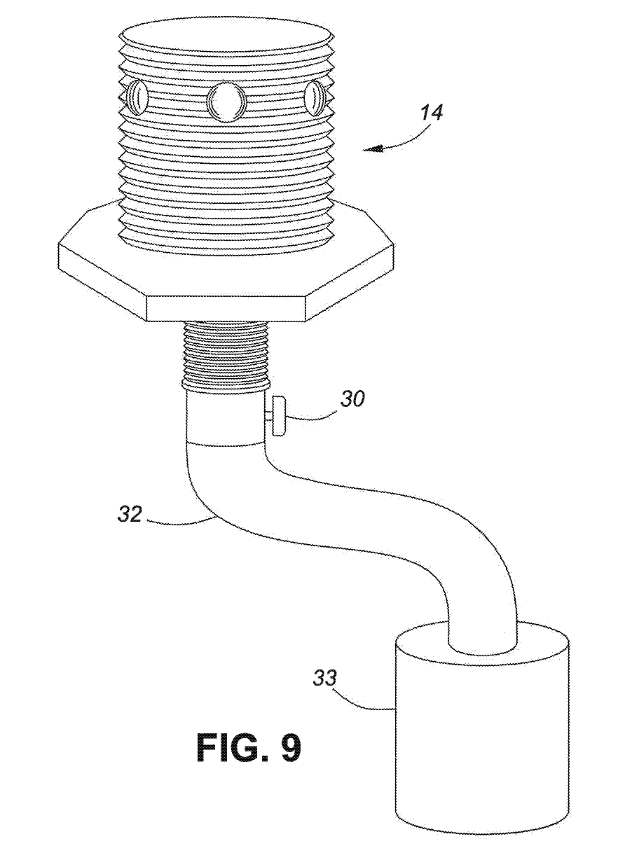

The adapter plug body 12 can also include a hose fitting 31 and hose 32 (FIG. 9) so that the lubricant can be drained into a separate exterior containment vessel 33 (FIG. 9). The lubricant can drain out via gravity feed or suction action.

When the lubricant is adequately drained out, the system can be removed from the housing. However it is important not to permit spillage.

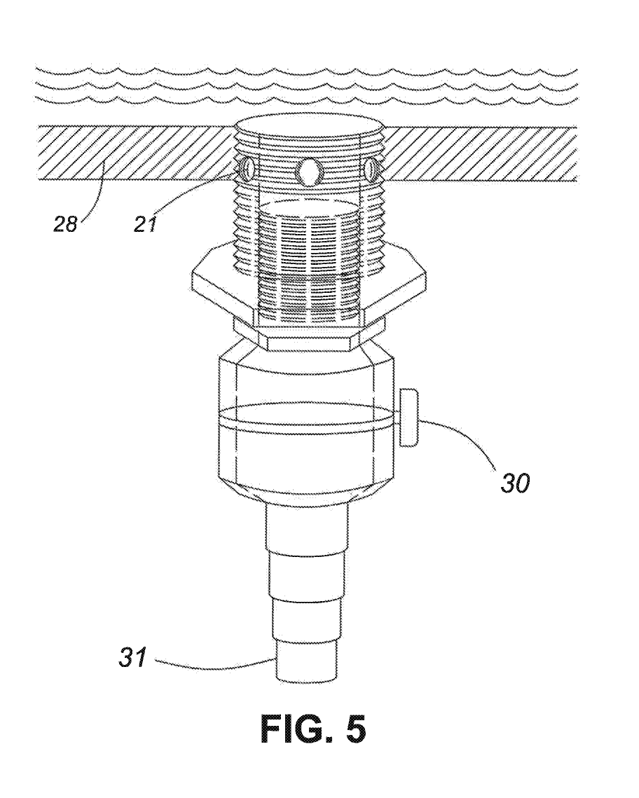

As seen in FIG. 5, to remove the lubricant drain plug system 10, the valve mechanism 30 is positioned in the ‘off’ position to stop oil flow through the hollow passage 15. The system 10 is then rotated about the drain/fill hole until the port holes 21 are sealed or blocked by the outer casing wall 28. In this way, lubricant flow 22 through the port holes 28 is prevented. Then the system can be removed therefrom safely without spillage of lubricant.

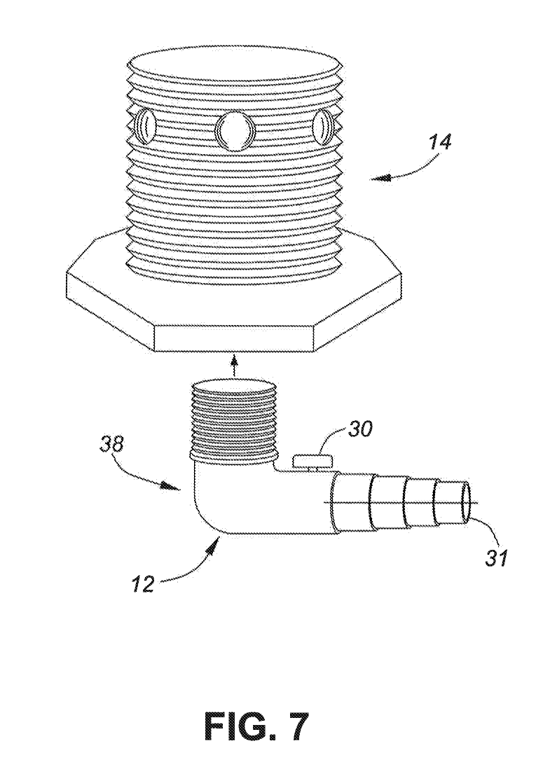

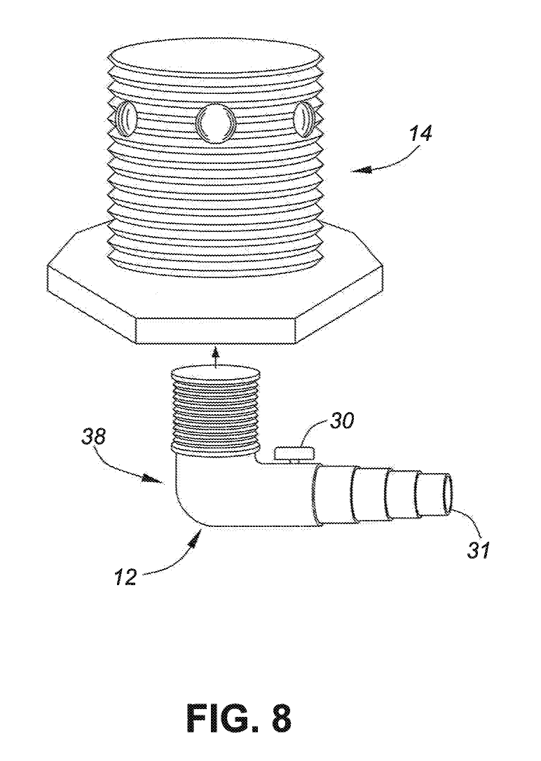

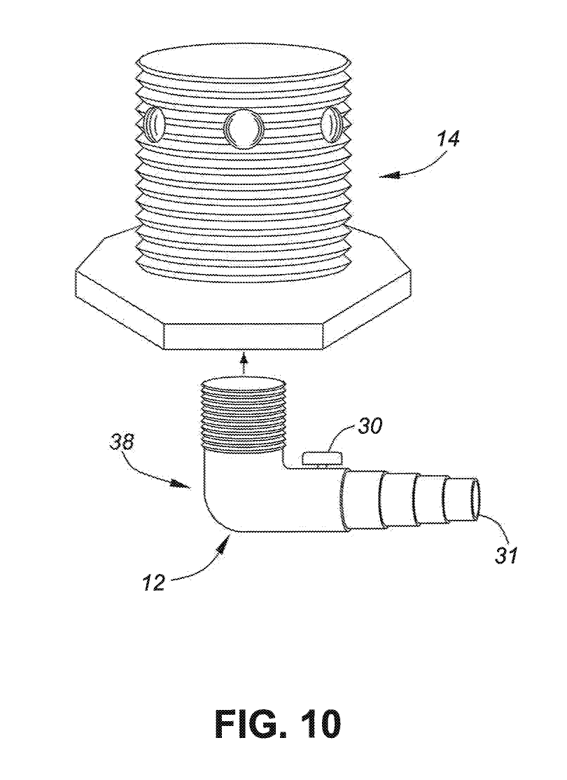

FIGS. 7 and 8 illustrates an embodiment of the invention using a swivel 38. FIG. 10 illustrates an embodiment of the invention without a swivel.

Embodiments of the lubricant drain plug system are made of a non ferrous main body, such as aluminum or brass, preventing thread damage to the main adapter body.

Numerous modifications may be made without departing from the spirit and scope of the invention as defined in the appended claims.

What is claimed is:

1. A lubricant drain plug system for a casing of moving mechanical parts in lubricant, the system comprising:
an adapter plug body;
an oil drainage assembly threadably mountable to the adapter plug body, the assembly having an outer plug with port holes; and
a valve mechanism on the adapter plug body, the valve mechanism being positionable in either an on or off position;
wherein in use, the system is inserted into the casing so that the port holes are in the lubricant and the valve is positioned in the on position so that lubricant can flow from the casing out of the system; and
wherein when the valve is off, lubricant flow is stopped.

2. The lubricant drain plug system of claim 1, wherein to stop lubricant flow, the system is positioned so that the port holes are sealed or blocked by the casing so that the system can be removed therefrom safely without spillage of lubricant.

3. The lubricant drain plug system of claim 1, further comprising a swivel.

4. The lubricant drain plug system of claim 1, further comprising a hose fitting and hose so that the lubricant can be drained into a separate exterior containment vessel.

5. The lubricant drain plug system of claim 4, wherein the lubricant drains out via gravity feed or suction action.

6. The lubricant drain plug system of claim 1, wherein the adapter plug body is made of a non ferrous metal, preventing thread damage to the adapter plug body.

7. The lubricant drain plug system of claim 6, wherein the non ferrous metal is aluminum or brass.
